(19) United States
(12) Patent Application Publication
(10) Pub. No.: US 2019/0073304 A1
(43) Pub. Date: Mar. 7, 2019

(54) COUNTING CACHE SNOOP FILTER BASED ON A BLOOM FILTER

(71) Applicant: ALIBABA GROUP HOLDING LIMITED, George Town (KY)

(72) Inventor: Xiaowei JIANG, San Mateo, CA (US)

(73) Assignee: ALIBABA GROUP HOLDING LIMITED

(21) Appl. No.: 15/698,583

(22) Filed: Sep. 7, 2017

(51) Int. Cl. G06F 12/0815; G06F 12/0811

(52) U.S. Cl. CPC G06F 12/0815; G06F 2212/60; G06F 2212/621; G06F 12/0811

(57) ABSTRACT

A system and method of a snoop filter providing larger address space coverage, freeing back-invalidation when an entry is evicted, and freeing excessive snoops when a snoop has a miss is provided. The snoop filter tracks the addresses of upper level cache lines at region basis, which enables a relatively smaller snoop filter with much larger address space coverage. The snoop filter is non-inclusive. The snoop filter is designed such that each upper level cache has its own bloom filter to track address space occupancy, eliminating a significant portion of conflict misses. The snoop filter is designed at a larger granularity such that applications have a much better spatial locality. The larger granularity employs coarse grain tracking techniques, which allow monitor of large regions of memory and use that infoiivation to avoid unnecessary broadcasts and filter unnecessary cache tag lookups, thus improving system performance and power consumption.

### TECHNICAL FIELD

The embodiments of the present application relate to a system and a method of improving existing snoop filter designs.

### BACKGROUND

When a bus transaction occurs to a specific cache block, all snoopers “snoop” the bus transaction. The snoopers look up their corresponding cache tag to check whether it has the same cache block. Certain cache operations, such as writes and cache misses, are broadcasted as a cache coherence message to other peer caches in a CPU. Each cache needs to monitor and respond to (i.e., snoop) the cache coherence requests from other caches using a cache coherence mechanism, such as a cache snoop.

When clients in a system maintain caches of a common memory resource, it is possible that each core of the CPU has a copy of the shared data in its own private cache. When one of the copies of data is modified, the other copies must reflect that change, else incoherent data problems may arise. In most cases the caches do not have the cache block containing the modified data, since a well optimized parallel program (or a single threaded application) does not share much data among threads. Thus, the cache tag lookup by the snooper increases the latency of cache operations and increases the amount of traffic on an on-die interconnect, especially for the cache that does not have the cache block. But the tag lookup also disturbs the cache access by a processor and incurs additional power consumption.

FIG. 1 is a block diagram of an exemplary multi-core CPU system 100 having multiple clients (e.g., Client₁ and Client₂), multiple caches (e.g., Cache₁ and Cacheₜ), and a common memory resource (e.g., MR₁). In the diagram, both Client₁ and Client₂ have a cached copy of a particular memory block from a previous read. Suppose Client₁ updates/changes that memory block, Client₂ could be left with an invalid cache of memory without any notification of the change, thereby resulting in a conflict. Cache Coherence Protocols are implemented to manage such conflicts by maintaining a coherent view of the data values in multiple caches, such as Cache₁ and Cache₂. To improve the efficiency of cache coherence operations, today's CPUs, such as Intel®'s x86 deploy on-chip snoop filters to eliminate the unnecessary cache coherence traffic. To mitigate the redundant cache coherence messages, modern CPUs deploy snoop filters in their lower cache hierarchy.

There are two primary problems with existing snoop filter design. First, they track the addresses in upper level caches at the granularity of a cache line. This implies providing large address space coverage, making the snoop filter large in size. Second, the snoop filter can be either inclusive or non-inclusive. An inclusive snoop filter has the drawback of needing back-invalidation when an entry is evicted, while a non-inclusive snoop filter requires excessive snoops when it has a miss. Thus, conventional snoop filter designs have several drawbacks primarily directed to tracking granularity and issues with inclusive and non-inclusive mechanisms.

### SUMMARY

Embodiments of the present disclosure provide a system and a method of improving conventional snoop filter design by providing a larger address space coverage, freeing back-invalidation of a snoop filter when an entry is evicted, and freeing excessive snoops when a snoop has a miss.

According to various embodiments, the system comprises a fabric communicatively coupled to a plurality of upper level caches associated with a plurality of cores, wherein the plurality of upper level caches include an address from a list of addresses to data, the fabric including one or more counting bloom filters configured to acquire a missed address from an upper level cache of the plurality of upper level caches, wherein the missed address corresponds to an index to a counter from a list of counters, and a snoop filter configured, based on a value of the counter, to identify an upper level cache of the plurality of upper level caches having the data, wherein the identified upper level cache provides a response with data associated with the missed address.

According to various embodiments, bits of the missed address are right-shifted, wherein the shift corresponds to a bit size of region of the counting bloom filter that acquires the missed address, wherein the missed address being shifted is inputted to a hash function to generate the index. According to various other embodiments, each of the one or more counting bloom filters comprises one or more counters, wherein the one or more counters contain hashed addresses indexed from a list of addresses, and wherein the snoop filter is further configured to acquire a value from each of the one or more counting bloom filters, wherein each counting bloom filter is associated with a respective upper level cache other than the upper level cachewith the missed address, evaluate the one or more acquired values. According to various other embodiments, if one of the acquired values is greater than zero, determine whether there is a snoop filter hit, and if the one or more acquired values is equal to zero, the data associated with the missed address cannot be acquired from the plurality of upper level caches.

According to various embodiments, the snoop filter is further configured to: if the snoop filter hit has not occurred, snoop one or more upper level caches that are associated with a counting bloom filter providing a value greater than zero, and if the snoop filter hit has occurred, snoop an array of bits, wherein each bit of the array of bits corresponds to a respective upper level cache.

According to various embodiments, each bit of the array of bits denotes presence or absence of the missed address in the one or more respective upper level caches, and wherein the snoop filter is further configured to send snoops to any one or more upper level caches corresponding to respective bits of an array of bits if a valid bit associated with the array of bits has been set.

According to various embodiments, the counting bloom filter that corresponds to the upper level cache having the missed address is further configured to an update by incrementing its counter, wherein the increment occurs after the missed address is provided by the upper level cache to the upper level cache requiring the missing data, and the one or more snoop filters used to identify one or more upper level caches of the plurality of upper level caches having the data are further configured to an update, wherein the update is accomplished by setting the bit, in the array of present bits, corresponding to the upper level cache in the plurality of upper level caches that responds with data associated with the missed address, and clearing the bit, in the array of present bits, corresponding to the upper level caches in the plurality of upper level caches that do not respond with data associated with the missed address.

According to various embodiments, the method comprising communicatively coupling the fabric to a plurality of upper level caches associated with a plurality of cores, wherein the plurality of upper level caches including an address from a list of addresses to data, acquiring, by the one or more counting bloom filters, a missed address from an upper level cache of the plurality of upper level caches, wherein the missed address corresponding to an index to a counter from a list of counters, and identifying, by the snoop filter and based on a value of the counter, an upper level cache of the plurality of upper level caches having the data, wherein the identified upper level cache providing a response with data associated with the missed address.

According to various embodiments, the method further comprising right-shifting bits of the missed address, wherein the shifting corresponding to a bit size of region of the counting bloom filter that acquires the missed address and inputting the missed address being shifted to a hash function generating the index.

According to various embodiments, the method further comprising assigning one or more counters to each of the one or more counting bloom filters, wherein the one or more counters containing hashed addresses indexed from a list of addresses.

According to various embodiments, the method further comprising acquiring, by the snoop filter, a value from each of the one or more counting bloom filters, wherein each counting bloom filter associating with a respective upper level cache other than the upper level cache with the missing address, evaluating the one or more acquired values, determining, if one of the acquired values is greater than zero, whether there is a snoop filter hit, and not acquiring the data associated with the missed address from the plurality of upper level caches if the one or more acquired values is equal to zero.

According to various embodiments, the method further comprising snooping, by the snoop filter, one or more upper level caches associated with a counting bloom filter providing a value greater than zero, snooping, by the snoop filter, an array of bits if the snoop filter hit has occurred, wherein each bit of the array of bits corresponding to a respective upper level cache, denoting presence or absence of the missed address in the one or more respective upper level caches, and sending snoops, by the snoop filter, to any one or more upper level caches corresponding to respective bits of an array of bits if a valid bit associated with the array of bits has been set.

According to various embodiments, the method further comprising updating, by the counting bloom filter corresponding to the upper level cache having the missed address, its counter, incrementing the counter of the counting bloom filter, wherein the incrementing occurs after the missed address is provided by the upper level cache to the upper level cache requiring the missing data, updating the one or more snoop filters used to identifying one or more upper level caches of the plurality of caches having the data, wherein the updating is accomplished by setting the bit in the array of bits corresponding to the upper level cache in the plurality of upper level caches responding with data associated with the missed address, and clearing the bit in the array of present bits corresponding to the upper level caches in the plurality of upper level caches not responding with data associated with the missed address.

### BRIEF DESCRIPTION OF THE DRAWINGS

FIG. 1 is a block diagram of an exemplary conventional multi-core CPU system.

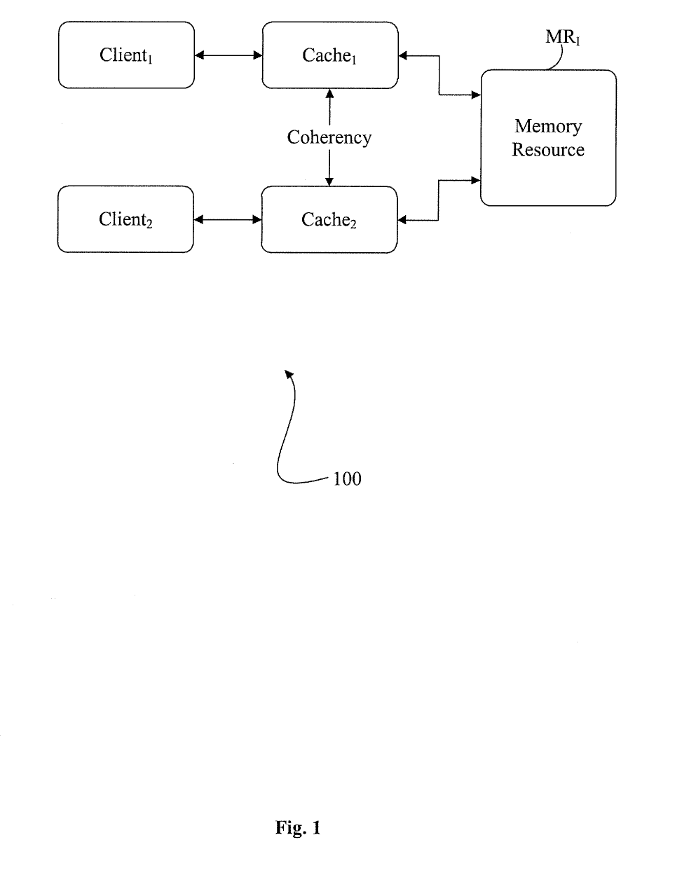

FIG. 2 is a block diagram of an exemplary conventional snoop filter.

FIG. 3 is a block diagram of an exemplary conventional snoop filter operation.

FIG. 4 is a schematic diagram of an exemplary multi-processing architecture, consistent with the embodiments of the present disclosure.

FIG. 5 is a block diagram of an exemplary snoop filter, consistent with the embodiments of the present disclosure.

FIG. 6 is a flowchart of an exemplary method in a fabric, consistent with embodiments of the present disclosure.

FIG. 7 is a flowchart of an exemplary method for L2 cache write-backs in a fabric, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

To mitigate unnecessary snooping, today's multi-core CPU systems use a cache snoop filter, i.e., a structure that tracks the presence of cache lines for all caches, and thus has the knowledge of whether a coherence request is actually needed. The filter determines whether a snooper needs to check its cache tag or not. The filter is based on a directory structure and monitors all coherent traffics to keep track of the coherency states of cache blocks. This means that the filter knows the caches that have a copy of a cache block. It can hence prevent the caches that do not have the copy of a cache block from making the unnecessary snooping.

As noted, in conventional multi-core CPU systems, each core is assigned with their own private caches, such as the lower level or Level 1 (L1) and upper level or Level 2 (L2) caches in Intel®'s x86 CPUs. Cache coherence problem arises because each cache has its own copy of shared data, and when modified locally by one cache, the copies in other caches effectively become stale. These conventional CPUs have well defined cache coherence mechanism that addresses the two primary problems with conventional snoop filter designs.

Cache coherence protocols define a sequence of operations that need to be performed carefully when a cache read, write, miss or evict takes place. For instance, when a cache is about to write into its own cache line, the cache needs to also send an invalidation coherence message to all other caches, so that another cache that has that line will drop its local copy. Likewise, when a cache miss occurs in one cache, an intervention message is broadcasted to all other caches to inquire if any of the other caches has a copy of the desired cache line; consequently, the owner of the cache line will reply with data.

Oftentimes cache coherence messages are redundant. For example, when running single-threaded programs, there are no data shared between the various caches. However, each cache still needs to broadcast invalidation and intervention messages to peer caches, and wait until all responses are collected before it can proceed. These unnecessary coherence message increases the performance cost of a cache miss, consumes bandwidth on the on-die interconnect just in order to send them, and wastes power as each peer cache needs to react to the coherence request.

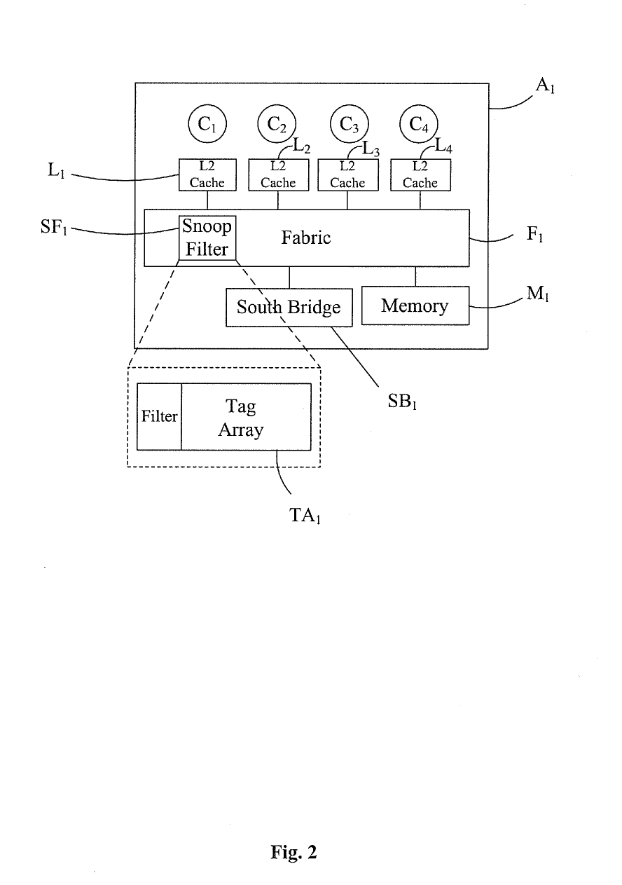

To mitigate the redundant cache coherence messages, conventional CPUs deploy the snoop filters in their lower cache hierarchy. These filters are typically associated with the CPU's last-level cache (such as in Xeon servers), or reside in the fabric that interconnects the CPU core blocks and peripherals (such as in Atom servers and some ARM servers). They use certain mechanisms to track the presence of an address in the upper level private caches. In order for the snoop filter to be effective, it needs to provide sufficient address space coverage for cache lines stored in upper level caches. As noted, conventional snoop filter designs have several drawbacks. One such drawback for conventional snoop filter designs is tracking granularity. In conventional snoop filter design, every cache line that is being brought into the L2 caches (e.g., L2 cache L₁ of FIG. 2 discussed later) is tracked. This essentially implies cache line granularity of address tracking in the snoop filter. It also implies the size of the snoop filter needs to be large in order to provide higher coverage for all of the cache lines in each of the L2 caches.

Another drawback for conventional snoop filter designs is inclusive and non-inclusive mechanisms. As noted previously, conventional snoop filters can be inclusive or non-inclusive. Inclusive snoop filters require that every eviction in the snoop filter requires the sending of a back-invalidation to the L2 caches to invalidate the line being evicted. This is because the snoop filter needs coverage for all of the cache lines in the L2 caches and thereby allow these L2 caches to contain any line the snoop filter does not have. However, sending back-invalidation reduces the benefits of the snoop filter, as it reduces the efficacy of L2 caches. On the other hand, employing a non-inclusive snoop filter implies that every miss in the snoop filter is required to snoop the L2 caches. This is because with the non-inclusive mechanism, L2 caches may have cache lines that are not covered by the snoop filter.

FIG. 2 is a block diagram of an exemplary conventional snoop filter SF₁. The diagram depicts a typical multi-processor architecture A₁ comprising four cores C₁-C₄ with L2 caches L₁-L₄ that incorporate snoop filters SF₁ in a fabric F₁. The multi-processor architecture depicted also comprises a memory M₁ and a south bridge SB₁, which typically manages basic forms of input/output (I/O) such as Universal Serial Bus (USB), serial, audio, Integrated Drive Electronics (IDE) and Industry Standard Architecture (ISA) I/O in a computer with an Intel® chipset. This is a common architecture for the Atom and ARM servers. It should be noted that other kinds of architecture are well within the scope of the present disclosure, but the discussion will center on the Atom and ARM servers merely for simplicity of illustration. In contrast, the Xeon servers involve more complex baseline coherence operations as they have 3-levels of caches. However, the scope of the present disclosure is equally applicable to all snoop filters, regardless of the levels of caches deployed.

Returning to FIG. 2, to track the cache line presence for all L2 caches L₁-L₄, snoop filter SF₁ resides in fabric F₁. A fabric in the Atom or ARM servers consists of a point-to-point interconnect, a memory controller, and system agents that connect to high-speed peripherals as well as south bridge SB₁. The snoop filter is designed similar to the structure of a cache. It consists of a tag array TA₁ so that each entry in the snoop filter can track the presence of a cache line in the L2 caches. The snoop filter also has a present bit for each entry it has.

In operation, when a snoop request (e.g., from L2 cache L₁) arrives at the fabric, to determine whether the snoop is actually needed, the snoop filter is checked. When an entry is found in the snoop filter and the present bit is set (e.g., present bit=1), the snoop needs to be broadcasted to all peer L2 caches L₂-L₄ of the requestor L2 cache L₁, or otherwise the snoop is not needed, as none of the L2 caches L₂-L₄ has the line.

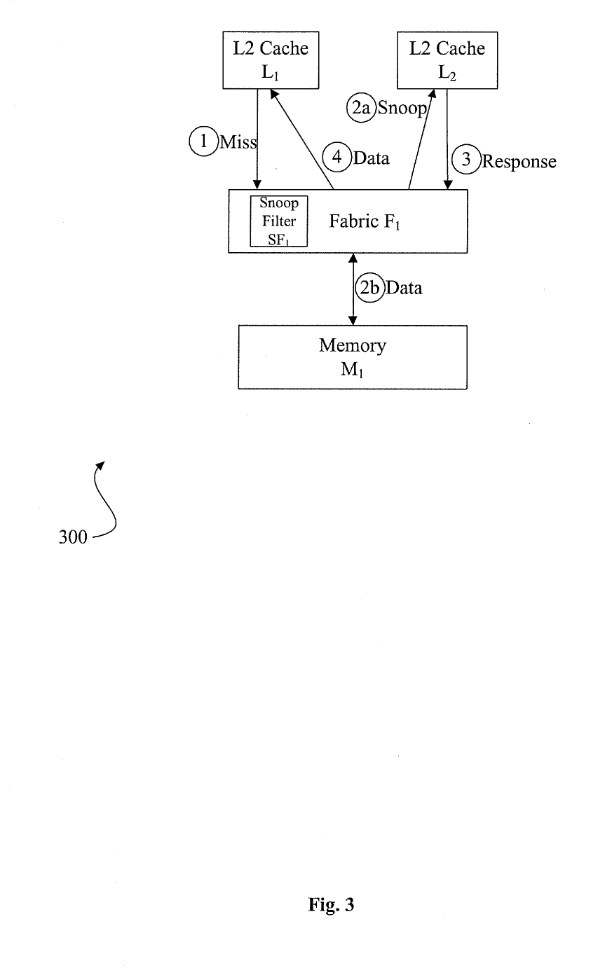

FIG. 3 is a block diagram of an exemplary conventional snoop filter SF₁ operation 300. The multi-processor architecture A₁ has two L2 caches L₁ and L₂. In operation and as shown by step 1, when the first L2 cache L₁ suffers a cache miss, it sends the miss request to the fabric F₁ that contains a snoop filter SF₁. Using the request, snoop filter SF₁ examines its tag array to determine whether it has the line. In situations where it has the line and the present bit is set (e.g., present bit=1), at step 2a, a snoop request is broadcasted to peer L2 cache, i.e., second L2 cache L₂. In the meantime, at step 2b, a memory request is sent to memory M₁. When second L2 cache L₂ receives the snoop, it checks itself and replies to the request. If second L2 cache L₂ has the line, at step 3, second L2 cache L₂ supplies data along with the response. When the data is received at the fabric (either from second L2 cache L₂ when it has the line or from main memory M₁, when second L2 cache L₂ does not have the line), at step 4 a final response with the data is returned to the requestor L2 cache L₁.

According to various embodiments of this disclosure, a fabric includes a counting bloom filter with a snoop filter, the combination of which can improve the existing snoop filter design and its operation. According to various embodiments, the snoop filter within the fabric tracks the addresses of cache lines in L2 caches at region basis, which enables a relatively smaller snoop filter that provides much larger address space coverage. According to various embodiments, the snoop filter within the fabric is a non-inclusive snoop filter, but it does not suffer from the excessive snoop problem when a miss occurs that conventional snoop filters have. According to various embodiments, the snoop filter within the fabric is capable of providing orders of magnitude larger coverage than conventional snoop filters and thus snoop filter misses are rare.

According to various other embodiments, the snoop filter within the fabric is designed such that each L2 cache has its own bloom filter to track address space occupancy in the L2 cache and thereby eliminating a significant portion of conflict misses among L2 caches in the snoop filter. According to various embodiments, the snoop filter within the fabric is designed at a larger granularity such that it can provide a larger coverage than a conventional snoop filter with the same size and applications have a much better spatial locality. According to various embodiments, the larger granularity employs coarse grain tracking techniques, which allow monitor of large regions of memory and use that information to avoid unnecessary broadcasts and filter unnecessary cache tag lookups, thus improving system performance and power consumption.

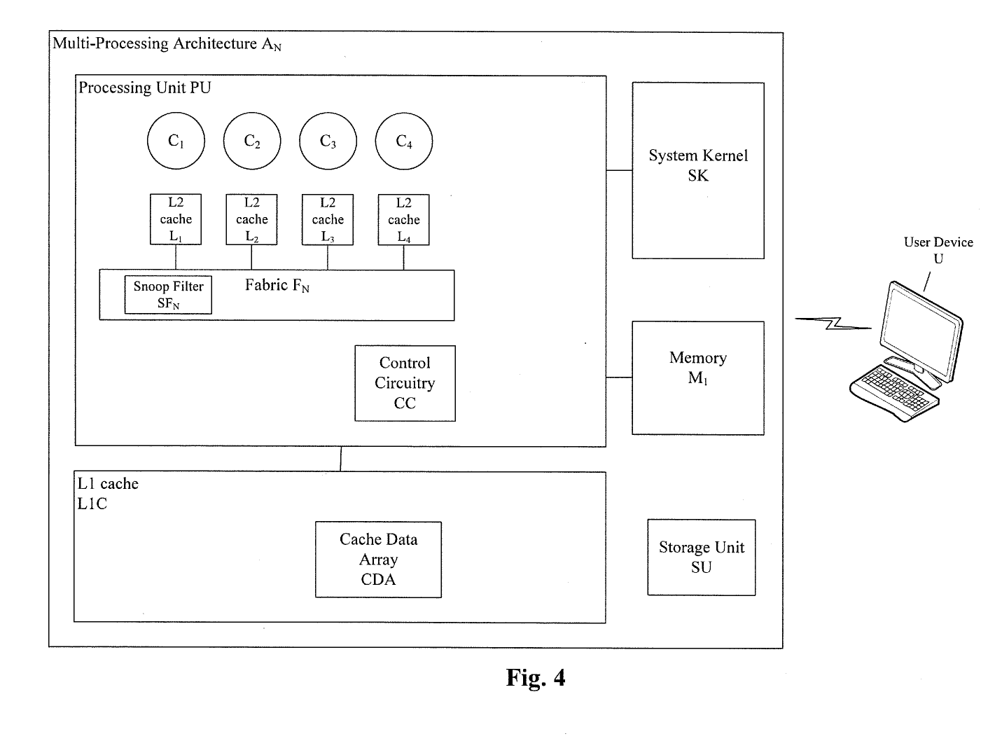

FIG. 4 is a schematic of an exemplary multi-processing architecture A_{N} consistent with embodiments of the present application. Multi-processing architecture A_{N} can be included in a cloud-based server of a service provider. The server can be accessed by a user device U via a network.

As shown in FIG. 4, multi-processing architecture A_{N} includes a processing unit PU, and a Level 1 cache (L1), a system kernel SK, and a memory M₁ coupled to processing unit PU. Memory M₁ can store data to be accessed by processing unit PU. System kernel SK can control the operation of multi-processing architecture A_{N}. Multi-processing architecture A_{N} includes a storage unit SU that stores a task_struct data structure that describes attributes of one or more tasks/threads to be executed on the multi-processing architecture A_{N}.

Processing unit PU and L1 cache L1C can be included in a CPU chip in which processing unit PU is disposed on a CPU die and L1 cache L1C is disposed on a die physically separated from the CPU die. Processing unit PU includes a plurality of processing cores C₁-C.₄, a plurality of L2 caches L₁-L₄ respectively corresponding to and coupled to the plurality of processing cores C₁-C₄ and coupled to a fabric F_{N}. The fabric F_{N} comprises a snoop filter SF_{N}. In addition, processing unit PU includes a last level cache (optional), and control circuitry CC. L1 cache L1C includes, amongst other components, a cache data array CDA.

As indicated above, the embodiments described herein provide a snoop filter design offering larger address space coverage, freeing back-invalidation of conventional snoop filters when an entry is evicted, and freeing excessive snoops when a snoop has a miss.

According to various embodiments, the snoop filter design tracks the addresses of cache lines in L2 caches, for example L2 caches L₁-L₄ at region basis. The tracking of the addresses of cache lines enables a relatively smaller snoop filter that provides much larger address space coverage. For example, the L2 cache size on a region basis could be 4 KB, as compared to 64 B on a cache line granularity.

According to various embodiments, the snoop filter can be a non-inclusive snoop filter. In spite of the snoop filter being non-inclusive, it does not suffer from the excessive snoop problem when a miss occurs that existing non-inclusive snoop filters have. This is because the coverage of the snoop filter can be orders of magnitudes larger than conventional snoop filters. As such, potential snoop filter misses are rare. In addition and according to various embodiments, the snoop filter is designed in a way that each L2 cache has its own bloom filter to track its address space occupancy in the L2 cache, thereby eliminating a significant portion of conflict misses among L2 caches in the snoop filter space.

The benefits of designing the snoop filter at larger granularity are twofold. First, at larger granularity, a snoop filter with the same size as a conventional snoop filter can provide larger coverage. Second, applications show a significant spatial locality at larger granularities. This indicates the potential for employing coarse grain tracking instead of cache-line based tracking in the snoop filter. For example, in conventional systems, for example the benchmark bzip2 in the SPEC2006 suite distributed the application space to 78% of the 8192 regions when using a 64 B region size (cache line size). However, when the region size is increased to 4 KB (page size), only 4% of the total regions are used. Other benchmarks in SPEC2006 all have similar results. In other words, if 4 KB of region size is used to track the addresses in L2 caches, the snoop filter can be designed to cover only 4% of the entire address space of an average application.

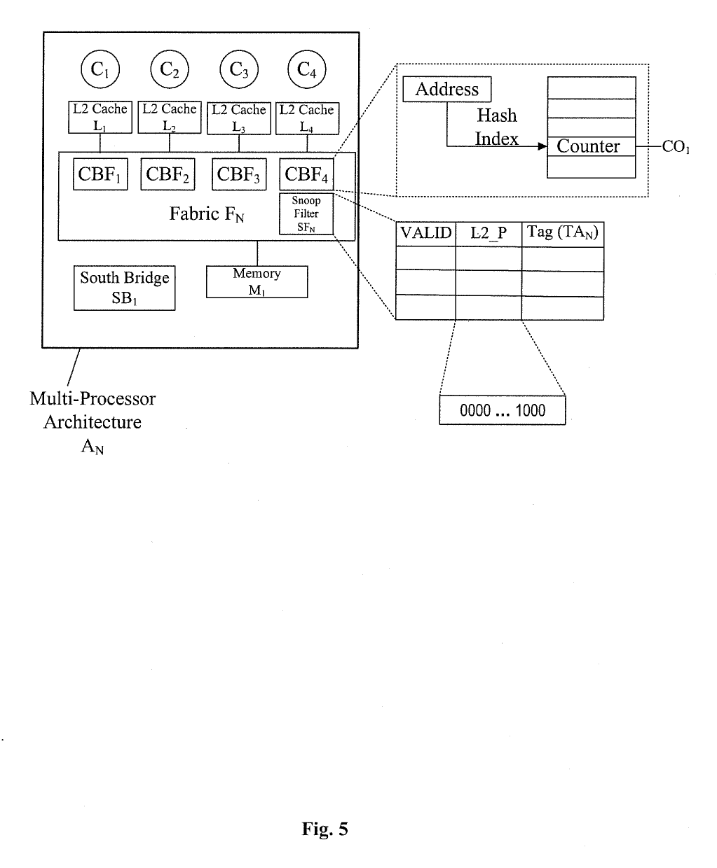

FIG. 5 is a block diagram of an exemplary snoop filter, consistent with the embodiments of the present disclosure. The diagram depicts a multi-processor architecture A_{N} comprising four cores C₁-C₄ with Level 2 caches L₁-L₄ incorporating a snoop filter SF_{N} in the fabric F_{N}. The multi-processor architecture depicted also comprises a memory M₁ and a south bridge SB₁, which typically manages basic forms of input/output (I/O) such as Universal Serial Bus (USB), serial, audio, Integrated Drive Electronics (IDE) and Industry Standard Architecture (ISA) I/O in a computer with an Intel® chipset. This is a common architecture for the Atom and ARM servers. It should be noted that other kinds of architecture are well within the scope of the present disclosure, but the discussion will center on the Atom and ARM servers merely for simplicity of illustration. In contrast, the Xeon servers involve more complex baseline coherence operations as they have 3-levels of cache. However, the scope of the present disclosure is equally applicable to snoop filters of the present disclosure, regardless of the levels of cache deployed. In other words, the snoop filters of the present disclosure function similarly with all kinds of processor architecture regardless of the levels of cache. Moreover, while the embodiments described herein are directed to the fabric communicating with a series of L2 caches, it is readily appreciated that the embodiments would work with a lower level cache, such as level-3 cache.

To reduce the unnecessary snoops sent to L2 cache locations L₁-L₄, a Counting Bloom Filter (CBF), e.g., CBF₁-CBF₄ is added for each L2 cache along with a snoop filter SF_{N}. Each bloom filter, e.g., CBF₄ comprises a list of counters, e.g., CO₁ and a set of hash functions that calculates the index to one of the counters based on the missed L2 cache address. The bloom filter acts as a probabilistic data structure that represents a set of data, and is able to provide an answer to whether a given data is likely in the set, or definitely not in the set. Because a plurality of data is hashed into a limited set of counters, bloom filters can have false positives, but never false negatives. The counting bloom filter CBF₄ in addition provides the ability to decrement a counter CO₁ in the filter.

Continuing with FIG. 5, the snoop filter design of the present disclosure also has a tag array (TA_{N}). However, instead of using a present bit as in the case of conventional snoop filters, the snoop filter uses an array of present bits (L2_P). Each bit in the array denotes the presence of the represented cache line in one of the L2 caches. For instance, a system with 16 L2 caches would require a 16-bit L2_P in each of the snoop filter entries. Since there are 4 L2 caches in FIG. 5, the array of present bits can range from 0000 to 1000. Further, a valid bit (VALID) is also augmented in each entry to facilitate the replacement policy in the snoop filter. When cleared, the entry becomes obsolete and can be the top candidate to be evicted for other lines.

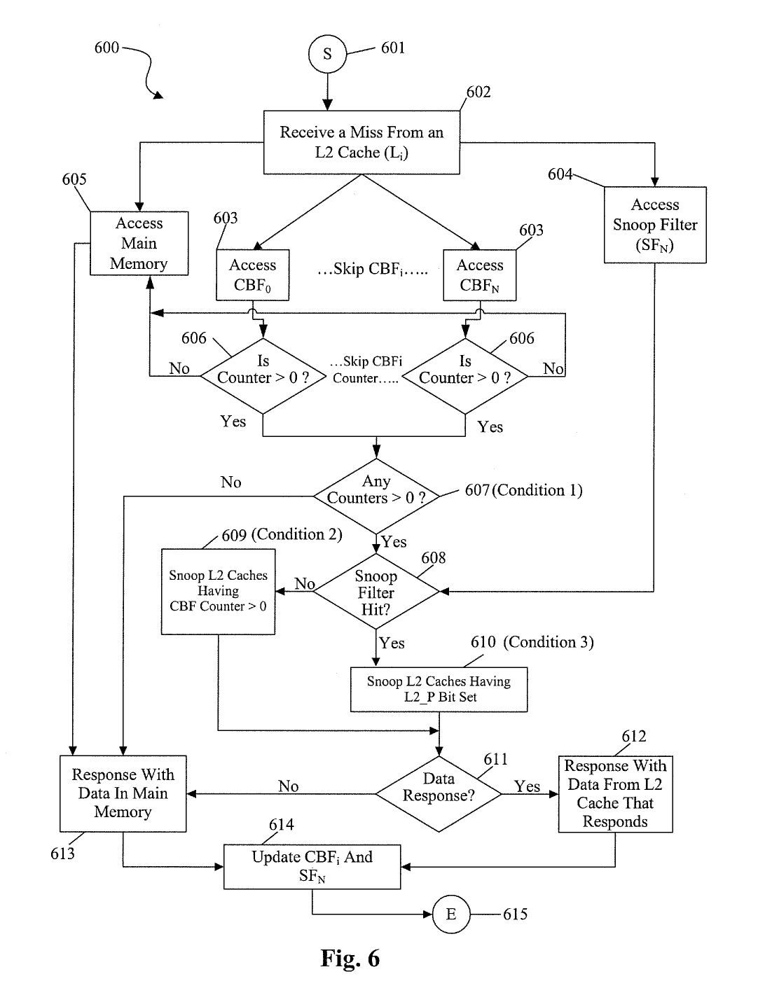

FIG. 6 is a flowchart representing an exemplary method 600 that takes place in a fabric (e.g., F_{N}), CBFs (e.g., CBF₁₋₄) comprising a snoop filter (e.g., SF_{N}) when a L2 cache miss request is delivered to the fabric, consistent with embodiments of the present disclosure. It is appreciated that the fabric F_{N} includes counting bloom filters (e.g., CBF₁₋₄) and snoop filter (e.g., SF_{N}) and that method 600 could be performed by the counting bloom filters and the snoop filter. It will also readily be appreciated that the illustrated procedure can be altered to delete steps or further include additional steps, as described below. Moreover, steps can be performed in a different order than shown in method 600, and/or in parallel. While the flowchart representing exemplary method 600 provides exemplary steps for a processor (e.g., an x86 Intel® processor) to implement the snoop filter, it is appreciated that one or more other processors from other manufacturers can perform substantially similar steps alone or in combination on a client end-device (e.g., a laptop or cellular device) or backend server regardless of the levels of cache or number of cache per level or the number of cores.

After initial step 601, a miss is received at step 602 from an L2 cache (e.g., from L2 cache Lᵢ). At steps 603, the fabric in parallel starts to access all remaining counting bloom filters (e.g., CBF₀-_{N}, except counting bloom filter CBFᵢ, which is associated with L2 cache Lᵢ). At step 604, the fabric can simultaneously access the snoop filter (e.g., SF_{N}) and; and at step 605, the fabric can also simultaneously access main memory (e.g., M₁). According to some embodiments, counting bloom filters CBF₀-_{N}, except CBFᵢ and the snoop filter SF_{N} are simultaneously accessed to figure out whether a snoop is needed at all. According to some embodiments, when a snoop is needed, instead of broadcasting to all L2 caches, only the L2 caches that are the appropriate recipient of the snoop receive the broadcast. According to some embodiments, the main memory can also be simultaneously accessed to avoid access latencies being serialized. When certain other conditions of using the snoop fail (discussed below), access to the main memory at step 605 can continue to step 613 where a response is obtained with the data from the main memory.

According to some embodiments, when each of the counting bloom filters (CBF_{0-N}, except CBFᵢ) is accessed, the missed L2 cache Lᵢ request's address is first right-shifted by the counting bloom filter region size. For example, if the counting bloom filter region size is 4 KB (2̂12), the request's address is first right-shifted by 12 bits. This ensures coverage of each entry in the counting bloom filter. According some embodiments, the result is then determined through the CBF's hashing functions. The result can be used as an index to lookup one of the counters (e.g., CO₁) in the counting bloom filter. The results from all counting bloom filters can be aggregated to identify if there are any counters greater than zero. When all counters are equal to zero, it implies that none of the remaining peer counter bloom filters have any data in its region (e.g., 4 KB) that the missed request's address resides in. As such there may not be any need to send snoops, and data response from main memory will be used to respond to the original L2 cache miss request (Condition 1 in FIG. 6).

Returning to FIG. 6, at steps 606, the counter of each L2 cache (except Lᵢ) is checked using the result of the hashing functions to see if any of the counters are greater than zero. If the counter of any of the L2 caches is not greater than zero (the “no” branches from 606), it means that those L2 caches do not have any data from their region (e.g., 4 KB) that the missed request's address resides in, and the method returns to step 605.

If the counter of any of the L2 caches is greater than zero (the “yes” branches from 606), Condition 1 comes into play, where at step 607 another check is made to see if any counters are greater than zero in order to apply the snoop. If at step 607 there are no counters greater than zero (the “no” branch from 607), the method continues to getting the response with the data in main memory (step 613).

In situations where there is one or more counting bloom filters' counters greater than zero, it is likely that these L2 caches may have that line. However, because bloom filters can have false positives due to collision, to further filter out unnecessary snoops, the result from the snoop filter can be examined. The snoop filter first looks up its tag array, e.g. TA_{N} and performs tag comparison with the missed request's address. If a snoop filter miss is found, the snoop filter is not able to further filter out the snoops (Condition 2). In this case, snoop requests are multi-casted to all L2 caches that have their corresponding counter greater than zero. If a snoop filter hit is found and the valid bit, e.g., VALID is set, the snoop filter is able to further filter out the snoops (Condition 3). In this case, snoop requests are sent to L2 caches that have their corresponding L2_P bit set in the snoop filter entry. It will be appreciated that the L2_P representation of address tracking is more precise than the CBF's, as the CBF has collisions. After snoop requests are sent to L2 caches, the fabric waits for a response. In case any of the L2 caches have the missed cache line, data will be supplied by that peer L2 cache in its response. The fabric will use the data from that peer L2 cache to respond to the miss requestor. In case none of the L2 caches has the missed cache line, the fabric can use the data returned by main memory (step 613) as the final response to the miss requestor.

According to some embodiments and in parallel to responding to the miss requestor, the CBF that is associated with the L2 cache that has the original miss (e.g., CBFᵢ) is updated by incrementing its corresponding counter. This reflects that Lᵢ now has a cache line in the denoted region. The snoop filter can also be updated by setting the ith bit in the corresponding L2_P. Furthermore, based on the responses from the peer L2 caches, the bits in L2_P that denotes peer L2 caches that did not respond with data can be cleared.

Returning to FIG. 6, step 604 and the “yes” branch from step 607 continue to step 608, where a check is made to see if there are snoop filter hits. If there are no hits (the “no” branch from step 608), the method continues to step 609, which is Condition 2 where all L2 caches having a CFB counter greater than zero are snooped.

If, on the other hand, there are snoop filter hits (the “yes” branch from step 608), the method continues to step 610, which is Condition 3 where all L2 caches having an L2_P bit set are snooped. Steps 609 and 610 continue to step 611, where a check is made to see if there is data in an L2 cache to respond with. If there is data (the “yes” branch from 611), at step 612 a response is made with the data from the L2 cache that has the data. If, on the other hand, there is no data (the “no” branch from 611), the method continues to step 613 where a response is made using data in the main memory. After steps 612 or 613, at step 614 the CBFi and the snoop filter SF_{N} are updated and the method ends at step 615.

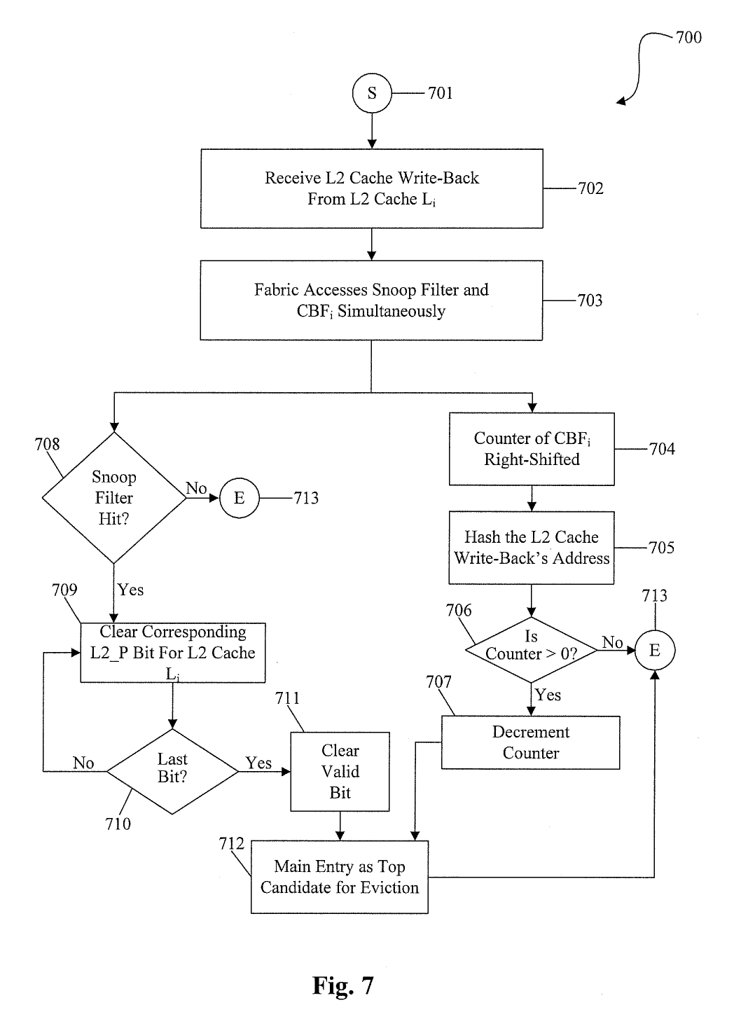

FIG. 7 is a flowchart representing an exemplary method 700 in a fabric (e.g., F_{N}) comprising a snoop filter (e.g., SF_{N}) on L2 cache write-backs, consistent with embodiments of the present disclosure. It is appreciated that the fabric includes counting bloom filters (e.g., counting bloom filters CBF_{1-N}) and a snoop filter (e.g., snoop filter SF_{N}) and that method 700 could be performed by the counting bloom filters and snoop filter. It will also readily be appreciated that the illustrated procedure can be altered to delete steps or further include additional steps, as described below.

According to some embodiments, the fabric accesses a counting bloom filter (e.g., counting bloom filter CBFᵢ) associated with a L2 cache (e.g., L2 cache Lᵢ) and a snoop filter (e.g., SF_{N}) simultaneously when it receives a L2 cache write-back. According to some embodiments, the counter (e.g., COᵢ) from the CBF (e.g., CBFᵢ) associated with the L2 cache is selected and right-shifted. According to other embodiments, the write-back's address is hashed, and if the counter is greater than zero, it is decremented and the entry is marked as a top candidate for eviction at the next go-around. According to other embodiments, the snoop filter SF_{N} is also accessed when a miss occurs. In case a hit is detected, according to some embodiments the corresponding ith bit in the entry's L2_P is first cleared; if that bit is not the last bit, continue clearing the corresponding L2_P bit for the L2 cache (Lᵢ). According to other embodiments, when a hit is detected and the corresponding ith bit in the entry's L2_P is the last bit, the bit is first cleared along with clearing the valid bit (e.g., VALID). According to some embodiments, after the valid bit is cleared the entry is marked as a top candidate for eviction in the next go-around.

Returning to FIG. 7, method 700 begins at step 701 and continues to step 702, where an L2 cache write-back is received by the fabric F_{N} from Lᵢ. Next, at step 703, the fabric F_{N} can simultaneously access the snoop filter SF_{N} and the counting bloom filter CBFᵢ for L2 cache Lᵢ that receives the cache write-back.

Next, the steps taken after simultaneously accessing the counting bloom filter is explained. At step 704, the counter (e.g., counter COᵢ) of the selected counting bloom filter CBFᵢ is right-shifted. Next, at step 705 Lᵢ's write-back address is hashed. Next, at step 706, a check is made to see if counter COᵢ is more than zero. If the counter is zero, or in other words, the counter is not more than zero (the “no” branch from 706), the method ends at step 713. If, on the other hand, counter COᵢ is more than zero (the “yes” branch from 706), the counter is decremented at step 707. Next, at step 712, the entry is marked as a top candidate for eviction in the next go-around.

Next, the steps taken simultaneously after accessing the snoop filter SF_{N} (at step 703) is explained. It should be noted that snoop filter SF_{N} is accessed when a miss occurs. At step 708, a check is made to see if snoop filter SF_{N} has a hit. If the snoop filter does not have a hit (the “no” branch from 708), the method ends at step 713. If, on the other hand, the snoop filter has a hit (the “yes” branch from 708), the method continues to step 709 where the corresponding L2_P bit for Lᵢ is cleared. Next, at step 710 another check is made to see if there are more bits (or if the remaining bit is the last bit). If the remaining bit is not the last bit (the “no” branch from 710), the flow returns to step 709. If, on the other hand, the remaining bit is the last bit (the “yes” branch from 710), at step 711 the valid bit (e.g., VALID) is cleared. Next, at step 712 the entry is marked as a top candidate for eviction at the next go-around and the method ends at step 713.

According to some embodiments, the bloom filter support serves as a first line of defense to filter out most of the unnecessary snoops. For instance, when running single-threaded applications that have no data sharing across CPU cores, an L2 cache miss received by the fabric will most likely encounter all peer CBFs with their corresponding counter equaling zero. However, because bloom filters can have false positives, the snoop filter of the present disclosure is used as a second line of defense to further filter out unnecessary snoops. According to some embodiments, no back-invalidation is needed when an entry in the snoop filter is evicted. Since the amount of request coming to the snoop filter is already significantly reduced by the CBFs, it becomes affordable to send multicast snoops when a snoop filter miss occurs.

According to some embodiments and as an alternative, a conventional snoop filter without a bloom filter can be used to track at a region basis. Such an approach includes region-granular snoops to be broadcasted instead of regular cache snoops. However, broadcasting can make the operation more expensive than the system and methods of the snoop filter of the present disclosure, as all caches receiving the snoop need to examine all cache lines in their regions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

1. A computer system comprising:
a fabric communicatively coupled to a plurality of upper level caches associated with a plurality of cores, wherein the plurality of upper level caches include an address from a list of addresses to data, the fabric including:
one or more counting bloom filters configured to acquire a missed address from an upper level cache of the plurality of upper level caches, wherein the missed address corresponds to an index to a counter from a list of counters; and
a snoop filter configured, based on a value of the counter, to identify an upper level cache of the plurality of upper level caches having the data, wherein the identified upper level cache provides a response with data associated with the missed address.

2. The computer system of claim 1, wherein the index is generated based on a right shifting of bits of the missed address, wherein the right shifting of bits corresponds to a bit size of region of the counting bloom filter that acquires the missed address.

3. The computer system of claim 2, wherein the missed address being shifted is inputted to a hash function to generate the index.

4. The computer system of claim 1, wherein each of the one or more counting bloom filters comprises one or more counters.

5. The computer system of claims 4, wherein the one or more counters contain hashed addresses indexed from a list of addresses.

6. The computer system of claim 5, wherein the snoop filter is further configured to:
acquire a value from each of the one or more counting bloom filters, wherein each counting bloom filter is associated with a respective upper level cache other than the upper level cache with the missed address;
evaluate the one or more acquired values;
if one of the acquired values is greater than zero, determine whether there is a snoop filter hit, and
if the one or more acquired values is equal to zero, the data associated with the missed address cannot be acquired from the plurality of upper level caches.

7. The computer system of claim 6, wherein the snoop filter is further configured to:
if the snoop filter hit has not occurred, snoop one or more upper level caches that are associated with a counting bloom filter providing a value greater than zero; and
if the snoop filter hit has occurred, snoop an array of bits, wherein each bit of the array of bits corresponds to a respective upper level cache.

8. The computer system of claims 7, wherein each bit of the array of bits denotes presence or absence of the missed address in the one or more respective upper level caches.

9. The computer system of claim 7, wherein the snoop filter is further configured to send snoops to any one or more upper level caches corresponding to respective bits of an array of bits if a valid bit associated with the array of bits has been set.

10. The computer system of claim 1, wherein the counting bloom filter that corresponds to the upper level cache having the missed address is further configured to increment a corresponding counter, wherein the incrementing occurs after the missed address is provided by the upper level cache to the upper level cache requesting the missing data.

11. The computer system of claim 9, wherein the snoop filter is further configured to:
set a bit, of the array of bits, corresponding to the upper level cache in the plurality of upper level caches that responds with data associated with the missed address, and
clear the bit, of the array of present bits, corresponding to the one or more upper level caches in the plurality of upper level caches that do not respond with data associated with the missed address.

12. A computer implemented method on a system comprising a fabric, one or more counting bloom filters and a snoop filter, the method comprising:
communicatively coupling the fabric to a plurality of upper level caches associated with a plurality of cores, wherein the plurality of upper level caches includes an address from a list of addresses to data;
acquiring, by the one or more counting bloom filters, a missed address from an upper level cache of the plurality of upper level caches, wherein the missed address corresponds to an index to a counter from a list of counters;
identifying, by the snoop filter and based on a value of the counter, an upper level cache of the plurality of upper level caches having the data, wherein the identified upper level cache provides a response with data associated with the missed address.

13. The method of claim 12 further comprising right-shifting bits of the missed address, wherein the right-shifting corresponds to a bit size of region of the counting bloom filter that acquires the missed address.

14. The method of claim 13 further comprising generating the index based on the right-shifted address being input to a hash function.

15. The method of claim 12 further comprising assigning one or more counters to each of the one or more counting bloom filters.

16. The method of claim 15 wherein the one or more counters include hashed addresses indexed from a list of addresses.

17. The method of claim 16 further comprising:
acquiring, by the snoop filter, a value from each of the one or more counting bloom filters, wherein each counting bloom filter associated with a respective upper level cache other than the upper level cache with the missing address;
evaluating the one or more acquired values; and
determining, based on whether the acquired values is greater than zero, whether there is a snoop filter hit.

18. The method of claim 17 further comprising:
snooping, by the snoop filter, one or more upper level caches associated with a counting bloom filter providing a value greater than zero; or
snooping, by the snoop filter, an array of bits if the snoop filter hit has occurred, wherein each bit of the array of bits corresponding to a respective upper level cache.

19. The method of claim 18 further comprising denoting presence or absence of the missed address in the one or more respective upper level caches.

20. The method of claim 18 further comprising, sending snoops, by the snoop filter, to any one or more upper level caches corresponding to respective bits of an array of bits if a valid bit associated with the array of bits has been set.

21. The method of claim 12 further comprising incrementing, by a counting bloom filter corresponding to the upper level cache having the missed address, a corresponding counter, wherein the incrementing occurs after the missed address is provided by the upper level cache to the upper level cache requiring the missing data.

22. The method of claim 21 further comprising:
setting, at the snoop filter, a bit in the array of bits corresponding to the upper level cache in the plurality of upper level caches responding with data associated with the missed address; and
clearing the bit in the array of bits corresponding to the upper level caches in the plurality of upper level caches not responding with data associated with the missed address.

23. A processing unit, comprising:
a fabric communicatively coupled to a plurality of upper level caches associated with a plurality of cores of the processing unit, wherein the plurality of upper level caches include an address from a list of addresses to data, the fabric including:
one or more counting bloom filters configured to acquire a missed address from an upper level cache of the plurality of upper level caches, wherein the missed address corresponds to an index to a counter from a list of counters; and
a snoop filter configured, based on a value of the counter, to identify an upper level cache of the plurality of upper level caches having the data, wherein the identified upper level cache provides a response with data associated with the missed address.

24. A processing unit, comprising:
a plurality of cores of the processing unit;
caches providing data to the plurality of cores, including cache lines;
a snoop filter configured to track the addresses of the cache lines at region basis, which decreases the size of the snoop filter.
